(19) United States
(12) Patent Application Publication
(10) Pub. No.: US 2010/0097591 A1
(43) Pub. Date: Apr. 22, 2010

(54) Exposure apparatuses and methods

(75) Inventors: Eul Tae Kim, Suwon-si (KR); Sang Don Jang, Ansan-si (KR); Hi Kuk Lee, Yongin-si (KR); Sang Hyun Park, Yongin-si (KR); Dong Seok Baek, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/588,389

(22) Filed: Oct. 14, 2009

(30) Foreign Application Priority Data
Oct. 17, 2008 (KR) 10-2008-0102056

(51) Int. Cl. G03B 27/42; G01B 11/00

(52) U.S. Cl. 355/53; 356/400

(57) ABSTRACT

An exposure apparatus may include: a stage configured to move a substrate; an optical unit configured to generate and project a plurality of laser beams; and a control unit configured to measure straightness of the stage by controlling the projection of the laser beams to an exposed surface of the substrate while moving the stage. A method to measure straightness of a stage in an exposure apparatus may include: placing a substrate on the stage; moving the stage and substrate; generating a plurality of laser beams; projecting the laser beams to the substrate on the stage; and measuring the straightness of the stage by projecting the laser beams to an exposed surface of the substrate.

### CROSS-REFERENCE TO RELATED APPLICATION(S)

This application claims priority from Korean Patent Application No. 10-2008-00102056, filed on Oct. 17, 2008, in the Korean Intellectual Property Office (KIPO), the entire contents of which are incorporated herein by reference.

### BACKGROUND

1. Field

Example embodiments relate to exposure apparatuses and/or methods to measure straightness of stages in maskless exposure apparatuses.

2. Description of the Related Art

Generally, when forming patterns on a substrate of flat panel display (FPD) devices such as an LCD display or a plasma display, first, a patterning material may be applied on the substrate and then may be selectively exposed using a photomask, thereby being changed in its chemical property. The chemically changed patterning material or the other part excluding the patterning material on the substrate may be selectively removed, accordingly forming the patterns.

However, as the substrate is enlarged and the patterns formed on an exposed surface becomes more precise, use of a maskless exposure apparatus that omits the photomask may be gradually increasing. The maskless exposure apparatus may form patterns by transferring a beam to a substrate, with pattern information in the form of electronic signals generated by an electronic device.

The maskless exposure apparatus may form the patterns on an exposed surface of the substrate while moving the substrate. Here, preciseness of a stage that moves the substrate may determine quality of the patterns formed on the exposed surface. Especially, straightness of the stage may directly influence the quality of the patterns.

Straightness may refer to a positional error occurring in a direction perpendicular to the movement of the stage. For example, in a stage that moves on a 2D plane, straightness of the stage with respect to an X-axis direction may substantially cause a positional error in a Y-axis direction, and/or straightness with respect to the Y-axis direction may substantially cause a positional error in the X-axis direction.

To this end, conventionally, devices to measure the positional error, such as an angle sensor, may have been dedicatedly installed to measure the straightness and accordingly compensates for the positional error. However, such dedicated installation of the measuring device may incur a structural installation error and an additional cost, and may interfere with a measurement path. Moreover, repetitiveness and reproducibility of the measuring work may be deficient since the device needs to be demounted and reassembled every time of the measurement. Also, while being installed, the device may even touch the stage being precisely set up, thereby deteriorating accuracy of compensation of the straightness.

### SUMMARY

Example embodiments may provide methods to measure straightness of a stage without requiring a dedicated measuring device, by using a beam unit constituting a maskless exposure apparatus.

According to example embodiments, an exposure apparatus may include a stage configured to move a substrate, an optical unit configured to generate and project a plurality of laser beams, and/or a control unit configured to measure straightness of the stage by controlling the projection of the laser beams to an exposed surface of the substrate while moving the stage.

According to example embodiments, a method to measure straightness of a stage in an exposure apparatus may include placing a substrate on the stage; moving the stage and substrate, generating a plurality of laser beams; projecting the laser beams to the substrate on the stage, and/or measuring the straightness of the stage by projecting the laser beams to an exposed surface of the substrate.

Additional aspects of the invention will be set forth in part in the description which follows and, in part, will be obvious from the description, or may be learned by practice of the invention.

In accordance with one aspect of the present invention, an exposure apparatus includes a stage that moves a substrate, an optical unit that generates a plurality of laser beams to be projected to the substrate, and a control unit that measures straightness of the stage by projecting the plurality of beams to an exposed surface of the substrate while moving the stage.

The optical unit may project the plurality of beams perpendicularly to the stage.

The optical unit may include a digital micro-mirror device (DMD) which modulates the projected beams according to patterns of the beams and projects the modulated beams to the exposed surface.

The stage may be moved by a predetermined distance in a scanning direction, and the control unit continuously projects the plurality of beams of the DMD to the exposed surface in accordance with the operation of the stage.

The stage may be moved by a predetermined distance in a scanning direction, and the control unit continuously projects the plurality of beams to the exposed surface in accordance with the operation of the stage.

The exposure apparatus may further include a measuring unit to measure a distance among the continuously projected beams, and the control unit may calculate a distance deflection to measure the exposure straightness using the measured distance among the beams.

The distance deflection may be calculated by an equation below:

dₙ₊₁=(Xₙ+dₙ)−Xₙ₊₁

in which Xₙ and Xₙ₊₁ refer to relative distances among the projected beams, and d₀ is 0.

The beam may have a spot type or linear type pattern.

In accordance with another aspect of the present invention, a method to measure straightness of a stage in an exposure apparatus includes moving the stage whereon a substrate is placed, generating a plurality of beams and projecting the beams to the substrate on the stage, and measuring straightness of the stage by projecting the plurality of beams to an exposed surface of the substrate.

The exposure apparatus may further include measuring relative distances among the beams being continuously projected, and the straightness measurement may be performed by calculating a distance deflection among the beams using the measured relative distances among the beams.

As can be appreciated from the above description, according to the embodiment of the present invention, a final exposure straightness may be measured by measuring relative distances among plural beams continuously projected in accordance with the operation of the stage moved by a predetermined distance by a digital micro-mirror device (DMD) of a maskless exposure apparatus. Therefore, the measurement and error compensation may be performed more accurately, repetitively and reproducibly, thereby enabling more precise patterns to be formed. This technology is applicable to fabrication of a semiconductor or a display having a large-area substrate, which requires high precision patterns, and effective in technological and economical aspects since being capable of improving straightness and reducing the cost.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a perspective view schematically showing the structure of an exposure apparatus according to example embodiments;

FIG. 2 is a perspective view showing the structure of an optical unit of the exposure apparatus according to example embodiments;

FIG. 3 is a perspective view schematically showing the structure of an exposure head of the exposure apparatus;

FIG. 4 is an enlarged perspective view of a digital micro-mirror device (DMD) of the exposure apparatus;

FIG. 5A and FIG. 5B are views illustrating the operation of the DMD;

FIG. 6 is a control block diagram of the exposure apparatus according to example embodiments;

FIG. 7 is a view showing spots of beams projected to a micro mirror of the DMD;

FIG. 8 is a view showing a moving direction of the beam in accordance with a moving direction of the stage of the exposure apparatus; and

FIG. 9 is a view showing a distance deflection of the beams continuously projected to an exposed surface in the exposure apparatus according to example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

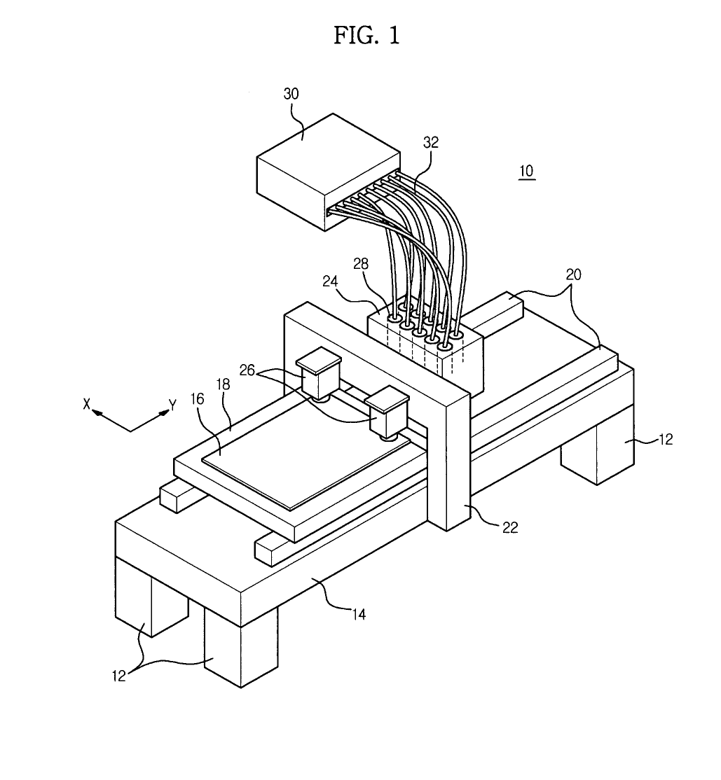

FIG. 1 is a perspective view schematically showing the structure of an exposure apparatus according to example embodiments.

Referring to FIG. 1, the exposure apparatus 10 may include a mounting base 14 in the form of a thick flat bed supported by supporting parts 12; a stage 18 mounted at an upper part of the mounting base 14 to scan an object of exposure, that is, a substrate 16 while moving the substrate 16 in a Y-axis direction; and/or a pair of guides 20 mounted to an upper surface of the mounting base 14 and/or extended along a moving direction of the stage 18. The stage 18 may be longitudinally extended along its moving direction and/or supported by the guides 20 to be movable in a reciprocating motion.

In the middle of the mounting base 14, a gate 22 having a flattened-U shape may be mounted to cross over the moving path of the stage 18 so that each end of the gate 22 is fixed to lateral sides of the mounting base 14. An optical unit 24 may be provided at one side of the mounting base 14 with reference to the gate 22 in order to generate beams to be projected to the substrate 16. A plurality of measuring units 26 (e.g., two) may be mounted at the other side of the mounting base 14 in order to measure the beams projected to the substrate 16. The optical unit 24 and/or the measuring units 26 may be attached to the gate 22 and/or fixedly disposed at an upper side of the moving path of the stage 18.

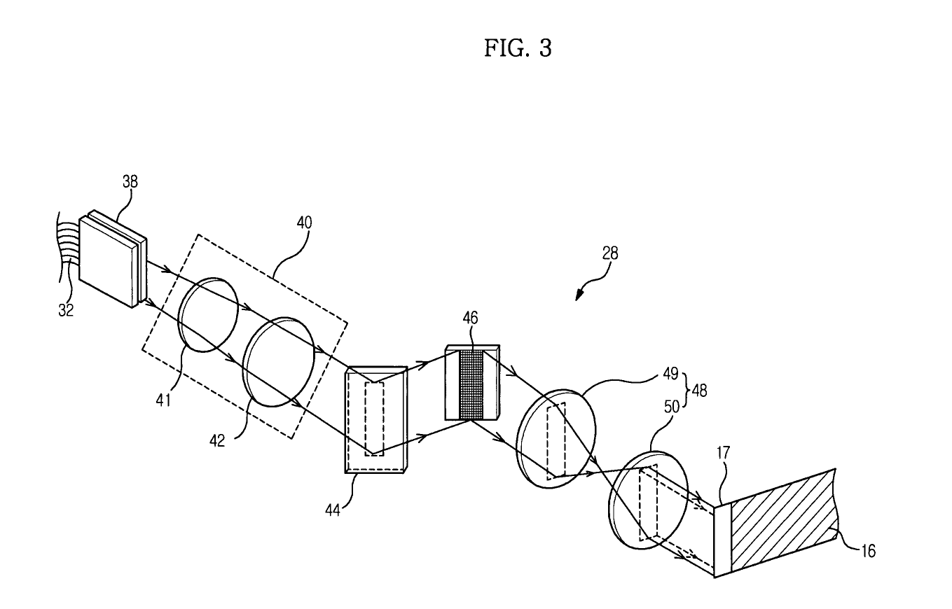

The optical unit 24 may include a plurality of exposure heads 28 that spatially modulates a laser beam projected from a light source 30 and/or project the modulated laser beam as an exposure beam to the substrate 16 having an exposed surface 17 (shown, for example, in FIG. 3). The respective exposure heads 28 may be connected to optical fibers 32 drawn out from the light source 30.

The light source 30 may comprise a semiconductor laser and/or an optical system that controls a laser beam projected by the semiconductor laser. The light source 30 may supply the laser beam to an incidence side of each of the exposure heads 28 of the optical unit 24.

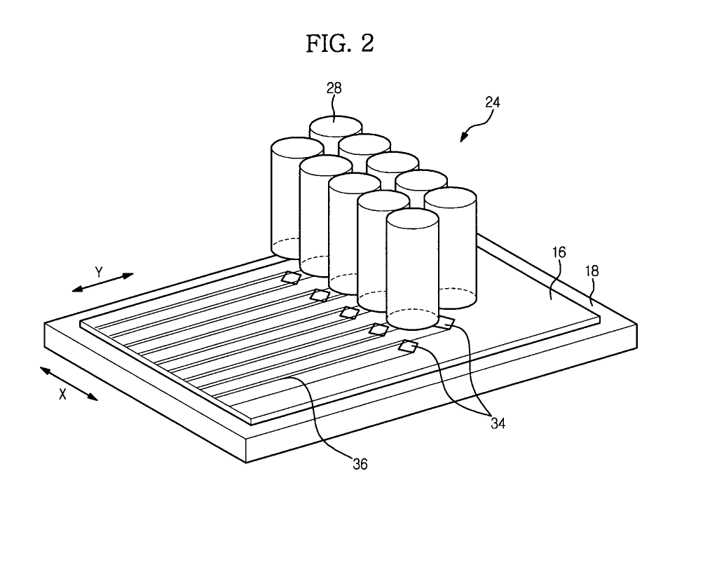

FIG. 2 is a perspective view showing the structure of the optical unit 24 according to example embodiments.

Referring to FIG. 2, the optical unit 24 may include the plurality of exposure heads 28 arranged in a matrix form of m-number rows by n-number columns, for example, 2 rows by 5 columns.

An exposure area 34 being scanned by the exposure head 28 may be formed in a rectangular shape having shorter sides in a scanning direction. As the stage 18 moves, an exposure completed area 36 for each exposure head 28 may be formed on the substrate 16 in a band form.

In addition, respective rows of the exposure heads 28 may be alternately arranged, being deviated from one another by a distance (that may or may not be predetermined) so that the exposure completed areas 36 in the band formed perpendicular to the scanning direction may be formed without gaps generated among them. For instance, there may be generated areas that could not be exposed between the respective adjoining exposure areas 34 of the first row. According to the above arrangement, however, these areas that could not be exposed may be exposed by the exposure areas 34 of the second row.

FIG. 3 is a perspective view schematically showing the structure of an exposure head of the exposure apparatus.

As shown in FIG. 3, each of the exposure heads 28 may comprise a compensation lens system 40 that may compensate for the beam projected from a beam projector end 38 of the optical fiber 32 and may project the compensated beam to a mirror 44. The mirror 44 may reflect the beam projected from the compensation lens system 40 to a digital micro-mirror device (DMD) 46. The DMD 46 may at least partially modulate a reflection angle of the beam reflected from the mirror 44 such that the projected beam has patterns (that may or may not be predetermined). The exposure head 28 further may comprise a condensing lens system 48 that focuses the beam modulated by the DMD 46 on the exposed surface 17 of the substrate 16.

The compensation lens system 40 may comprise a first compensation lens 41, controlling the beams projected from the beam projector end 38 to be uniform, and/or a second compensation lens 42, focusing the beams passed through the first compensation lens 41 on the mirror 44. Accordingly, the beams projected from the beam projector end 38 may be incident to the mirror 44 as uniformly distributed.

The mirror 44 may have a reflection surface on one side in order to reflect the beam passed through the compensation lens system 40 to the DMD 46.

The DMD 46 may function as a spatial optical modulator that may modulate the incident beams per pixel according to desired patterns. For this, the DMD 46 may include a plurality of micro mirrors 45 of which angles of the reflection surfaces may be varied in accordance with control signals, the micro mirrors 45 arranged on a 2D plane of a silicon semiconductor substrate by L-number rows by M-number columns. As the DMD 46 performs scanning in a certain direction along the exposed surface 17, the beams having patterns (that may or may not be predetermined) may be reflected to the condensing lens system 48.

In the condensing lens system 48 comprising a first condensing lens 49 and/or a second condensing lens 50, a focusing position of the pattern beams passed through the condensing lens system 48 may be controlled by adjusting a distance between the first condensing lens 49 and the second condensing lens 50. Therefore, the beams modulated by the DMD 46 may be incident to the exposed surface 17 of the substrate 16, accordingly curing or softening a photoconductive material formed at the exposed surface 17 of the substrate 16.

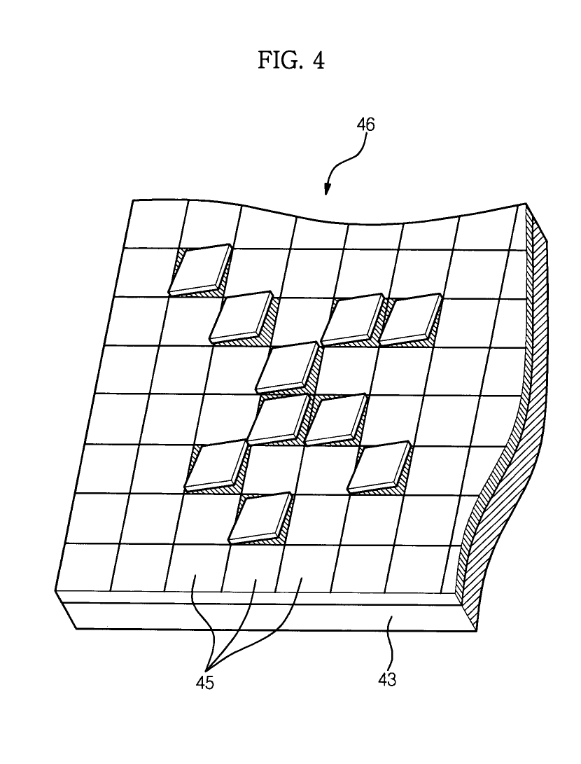

FIG. 4 is an enlarged perspective view showing the structure of the DMD 46.

Referring to FIG. 4, the DMD 46 may be a mirror device wherein the plurality of micro mirrors 45 constituting pixels may be arranged in a lattice form on a memory cell 43. A high-reflectivity material such as Al may be vapor-deposited on surfaces of the micro mirrors 45.

When a digital signal is recorded to the memory cell 43, the micro mirrors 45 corresponding to the digital signals may be slanted in a diagonal direction thereof by an angle (that may or may not be predetermined), for example 12 degrees, with respect to the substrate 16 where the DMD 46 may be placed. On and off states of the respective micro mirrors 45 may be controlled by a control unit 62 that will be explained later. The beams reflected by the micro mirrors 45 in the on state may be modulated to an exposure mode, so as to be projected to the exposed surface 17 through the condensing lens system 48. On the other hand, the beams reflected by the micro mirrors 45 in the off state may be modulated to a non-exposure mode, so that the beams are not projected to the exposed surface 17.

In addition, the DMD 46 may be slanted so that a shorter side thereof forms an angle (that may or may not be predetermined) with respect to the scanning direction.

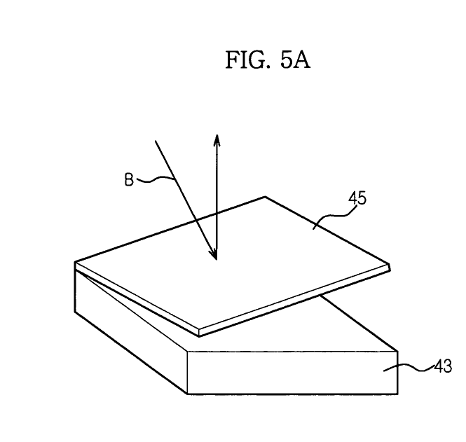

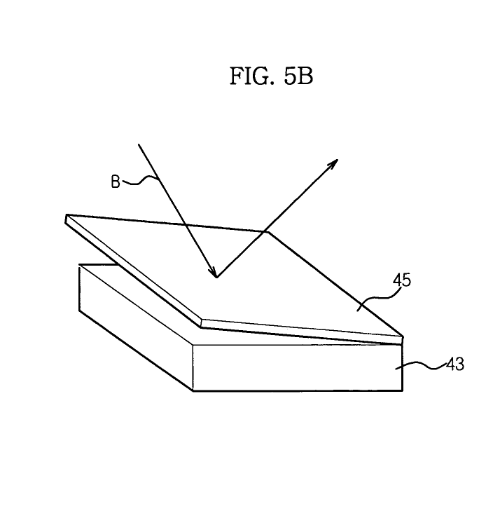

FIG. 5A and FIG. 5B illustrate the operation of the DMD 46 according to example embodiments.

FIG. 5A shows the on-state micro mirror 45 being slanted by an angle (that may or may not be predetermined), for example +12 degrees, while FIG. 5B shows the off-state micro mirror 45 being slanted by an angle (that may or may not be predetermined), for example −12 degrees. Thus, the slanted angles of the micro mirrors 45 in the pixels of the DMD 46 may be controlled by the control signals from the control unit 62, thereby reflecting the beams B being incident to the DMD 46 according to the slanted directions of the respective micro mirrors 45.

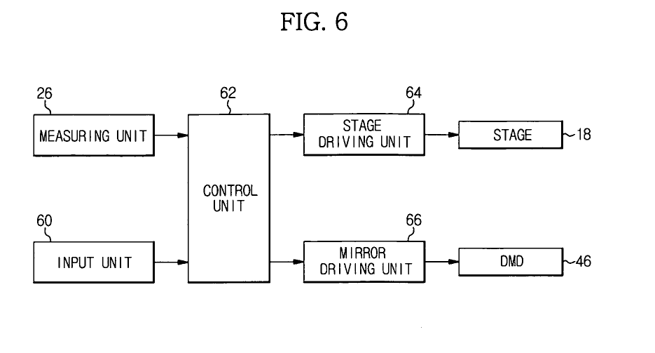

FIG. 6 is a control block diagram of exposure apparatus 10 according to example embodiments. The exposure apparatus may comprise measuring unit 26, input unit 60, control unit 62, stage driving unit 64, and/or mirror driving unit 66. Mirror driving unit 66 may drive, for example, DMD 46 of exposure head 28 of optical unit 24.

The measuring unit 26, for example, an interferometer, may measure distances among the beams being continuously projected to the exposed surface 17 (shown, for example, in FIG. 3) and/or may input the distance information to the control unit 62. Although a plurality of the measuring units 26 may be mounted to the gate 22 in example embodiments, example embodiments are not limited to such a structure, but may employ only one measuring unit 26. Also, the measuring unit 26 may be fixed to the stage 18.

The input unit 60 may input various exposure information necessary to measure the straightness of the stage 18 to the control unit 62. The exposure information may include a Y-axis directional moving distance of the stage 18, an X-axis directional distance among the exposure beams, the number of the exposure beams, and/or a shape of the exposure beam.

The control unit 62 may control the overall operations of the exposure apparatus 10, and/or may measure and/or compensate for the straightness of the stage 18 using a plurality of beams (for example, two beams) projected to the exposed surface 17 while moving the stage 18 by a distance (that may or may not be predetermined). The beams may or may not be continuously projected.

Furthermore, the control unit 62 may calculate a deflection value for measurement of the straightness of the stage 18 using the distances among the exposure beams, more specifically, relative distances among the exposure beams, and/or may measure and/or compensate for the straightness of the stage 18 according to the deflection value.

The stage driving unit 64 may operate the stage 18 according to the control signal from the control unit 62 so that the stage 18 may move the guides 20 by a distance (that may or may not be predetermined). The mirror driving unit 66 may turn on and off the DMD 46 so as to project the beams having desired patterns to the exposed surface 17 according to the control signals from the control unit 62.

Hereinafter, the operation processes of the above-structured exposure apparatus and the method of measuring the straightness, and the operation effects will be explained in detail.

The exposure information required for measurement of the straightness of the stage 18, including the Y-axis directional moving distance of the stage 18, the X-axis directional distance among the exposure beams, the number of the exposure beams, and/or the shape of the exposure beam, may be input to the control unit 62 through the input unit 60.

The control unit 62 may output the control signals to the stage driving unit 64 and/or the mirror driving unit 66 according to the exposure information input through the input unit 60.

According to the control signals, the stage driving unit 64 may move the stage 18 in the Y-axis direction by the distance (that may or may not be predetermined) such that the exposed surface 17 of the substrate 16 placed on the stage 18 may be exposed to the beams.

Simultaneously, the mirror driving unit 66 may drive the DMD 46 according to the control signals of the control unit 62, so that the DMD 46 may modulate the beams being incident through the compensation lens system 40 in every pixel according to the desired patterns and therefore the beams having patterns (that may or may not be predetermined) may be reflected to the condensing lens system 48.

More specifically, the laser beam may be projected from the light source 30 and/or supplied to the optical unit 24 through the optical fibers 32. By the respective exposure heads 28 of the optical unit 24, the laser beams supplied from the light source 30 may be projected to the DMD 46, passed through the mirror 44 and/or the compensation lens system 40, and/or projected to the pixels corresponding to the micro mirrors 45 of the DMD 46.

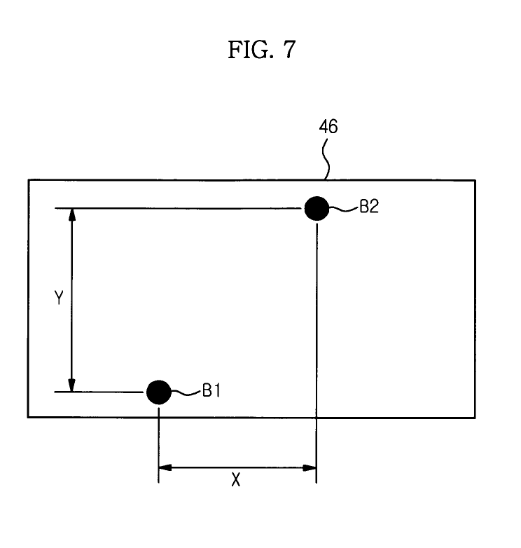

FIG. 7 shows spots of the beams projected to the micro mirror 45 of the DMD 46.

Referring to FIG. 7, the beams may be projected to the micro mirror 45 of the DMD 46 as the respective micro mirrors 45 are turned on and off according to the control signals of the control unit 62. Here, the beams reflected by the on-state micro mirrors 45 may be modulated to the exposure mode, thereby being projected to the exposed surface 17 through the condensing lens system 48. Meanwhile, the beams reflected by the off-state micro mirrors 45 may be modulated to the non-exposure mode, and therefore may not be projected to the exposed surface 17.

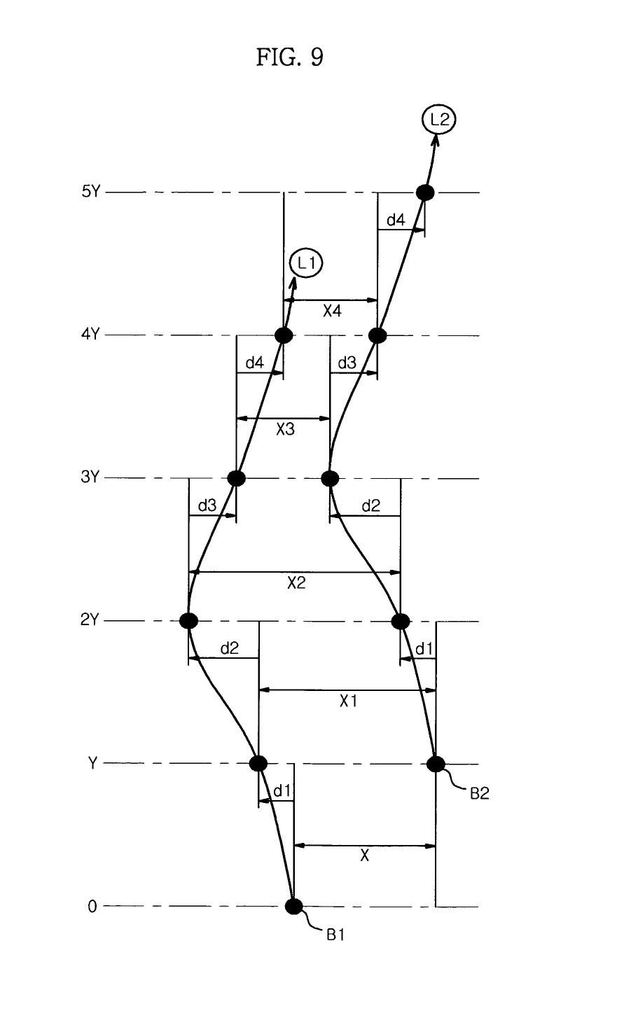

According to example embodiments, two beams B1 and B2 may be projected to the micro mirrors 45 of the DMD 46 in order to measure the straightness of the stage 18. Since an X-axis directional distance between the two beams B1 and B2 (“X” in FIGS. 7 and 9) and a Y-axis directional distance between the two beams B1 and B2 (“Y” in FIGS. 7-9) may correspond to the X-axis directional distance and the Y-axis directional distance between the beams at the exposed surface 17 measured through a position measuring device (not shown), the control unit 62 may obtain the X-axis and Y-axis distances between the beams B1 and B2.

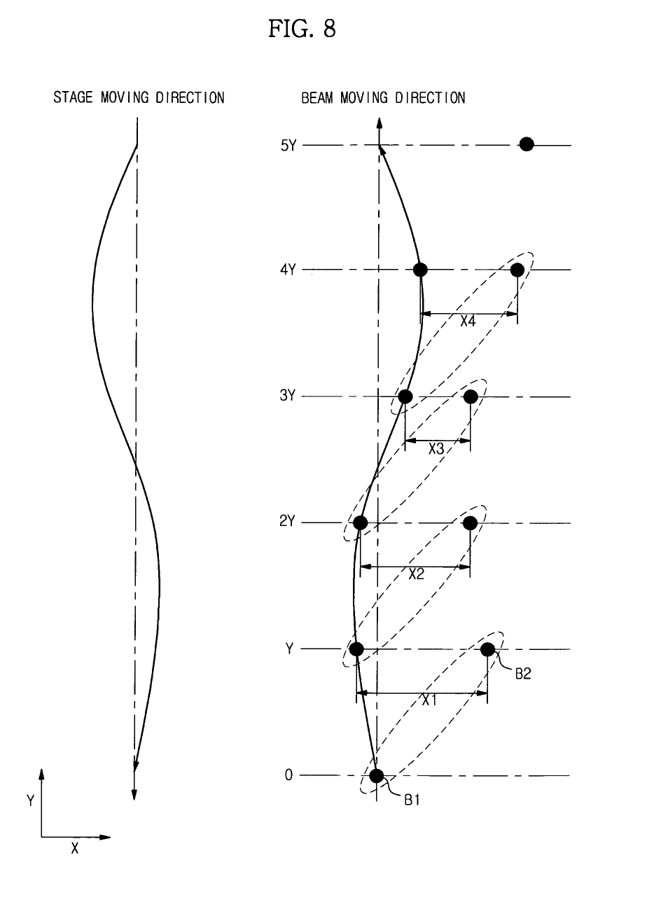

FIG. 8 shows a moving direction of the beam being projected to the exposed surface in accordance with the moving direction of the stage. The beams B1 and B2 moved relative to the movement of the stage 18 may be projected onto the exposed surface 17 in the spot form by every Y-axis directional distance (1Y, 2Y, 3Y . . . ) of the stage 18.

As shown in FIG. 8, straightness of the stage 18 may be generated perpendicular to its Y-directional moving direction, that is, in the X-axis direction. Accordingly, the spots of the beams B1 and B2 on the exposed surface 17 may be actually shifted in the X-axis direction, generating the exposure straightness.

Thus, a final exposure straightness may be measured by continuously projecting the two beams B1 and B2 to the exposed surface 17. For this, while moving the stage 18 by the distance (that may or may not be predetermined) (1Y, 2Y, 3Y . . . ) in the Y-axis direction, the relative distances X1, X2, X3, . . . , Xn between the two beams B1 and B2 being projected to the exposed surface 17 may be measured through the measuring units 26 mounted to the stage 18 or the gate 22 and/or input to the control unit 62.

Therefore, the control unit 62 may calculate the deflection to measure the straightness of the stage 18 using the measured relative distances between the beams, according to an equation below.

dn+1=(Xn+dn)−Xn+1 [Equation]

wherein, Xn and Xn+1 refer to the relative distances between the projected beams, and d0 is 0.

FIG. 9 is a view showing a distance deflection of the beam continuously projected to the exposed surface.

Referring to FIG. 9, the two beams B1 and B2 may be continuously projected by the distance (that may or may not be predetermined) (1Y, 2Y, 3Y . . . ) as the stage 18 moves, generating the exposure straightness in the respective lines L1 and L2 according to the straightness of the stage 18. Consequently, the deflection may be generated in the X-axis direction.

Therefore, as shown in FIG. 9, the control unit 62 may calculate the exposure straightness deflection using the Equation dn+1=(Xn+dn)−Xn+1, thereby measuring the final exposure straightness.

Thus, compared to the conventional measuring method that may require a dedicated measuring device, example embodiments may measure the straightness using the existing optical unit 24 already mounted to the exposure apparatus 10, incurring no additional cost and/or enabling repetitive and/or reproducible measurement. Accordingly, economical efficiency may be improved. In addition, since the straightness may be measured based on the final exposure result, measurement and/or compensation of the straightness may be more precisely performed.

Although the exposure straightness may be measured through the two beams B1 and B2 projected to the DMD 46 in example embodiments, example embodiments are not limited to this embodiment. That is, the same effect may be obtained by projecting two or more beams to the DMD 46.

Also, example embodiments may employ the exposure beams B having the spot type patterns. However, according to example embodiments, exposure beams having linear patterns in the scanning direction may also be used for the same purpose and effect.

While example embodiments have been particularly shown and described, it will be understood by those of ordinary skill in the art that various changes in form and details may be made therein without departing from the spirit and scope of the present invention as defined by the following claims.

What is claimed is:

1. An exposure apparatus, comprising:
a stage configured to move a substrate;
an optical unit configured to generate and project a plurality of laser beams; and
a control unit configured to measure straightness of the stage by controlling the projection of the laser beams to an exposed surface of the substrate while moving the stage.

2. The apparatus of claim 1, wherein the optical unit projects the laser beams perpendicularly to the stage.

3. The apparatus of claim 1, wherein the optical unit comprises a digital micro-mirror device (DMD) that modulates the projected laser beams according to patterns of the laser beams and reflects at least a portion of the modulated laser beams to the exposed surface.

4. The apparatus of claim 3, wherein the stage is moved by a predetermined distance in a scanning direction, and
wherein the control unit controls the projection of the laser beams so that the at least a portion of the modulated laser beams is continuously reflected from the DMD to the exposed surface in accordance with operation of the stage.

5. The apparatus of claim 1, wherein the stage is moved by a predetermined distance in a scanning direction, and
wherein the control unit controls the projection of the laser beams so that at least a portion of the laser beams is continuously projected to the exposed surface in accordance with operation of the stage.

6. The apparatus of claim 4, further comprising:
a measuring unit configured to measure a distance among the continuously reflected laser beams;
wherein the control unit calculates a distance deflection to measure the straightness using the measured distance among the continuously reflected laser beams.

7. The apparatus of claim 6, wherein the distance deflection dₙ₊₁ is calculated by the equation below:
dₙ₊₁=(Xₙ+dₙ)−Xₙ₊₁;
wherein Xₙ and Xₙ₊₁ refer to relative distances among the continuously reflected laser beams, and
wherein d₀ is 0.

8. The apparatus of claim 5, further comprising:
a measuring unit to measure a distance among the continuously projected laser beams;
wherein the control unit calculates a distance deflection to measure the straightness using the measured distance among the continuously projected laser beams.

9. The apparatus of claim 8, wherein the distance deflection dₙ₊₁ is calculated by the equation below:
dₙ₊₁=(Xₙ+dₙ)−Xₙ₊₁;
wherein Xₙ and Xₙ₊₁ refer to relative distances among the continuously projected laser beams, and
wherein d₀ is 0.

10. The apparatus of claim 1, wherein at least some of the laser beams have a spot type or linear type pattern.

11. The apparatus of claim 3, wherein the optical unit further comprises:
a beam projector; and
a compensation lens system;
wherein the compensation lens system is disposed between the beam projector and the DMD.

12. The apparatus of claim 3, wherein the optical unit further comprises:
a condensing lens system;
wherein the condensing lens system is disposed between the DMD and the exposed surface.

13. The apparatus of claim 3, wherein the optical unit further comprises:
a beam projector;
a compensation lens system; and
a condensing lens system;
wherein the compensation lens system is disposed between the beam projector and the DMD, and
wherein the condensing lens system is disposed between the DMD and the exposed surface.

14. A method to measure straightness of a stage in an exposure apparatus, comprising:
placing a substrate on the stage;
moving the stage and substrate;
generating a plurality of laser beams;
projecting the laser beams to the substrate on the stage; and
measuring the straightness of the stage by projecting the laser beams to an exposed surface of the substrate.

15. The method of claim 14, wherein the stage is moved by a predetermined distance in a scanning direction, and
wherein the laser beams are projected to the exposed surface according to the movement of the stage.

16. The method of claim 15, further comprising:
measuring relative distances among the laser beams being projected;
wherein the straightness is measured by calculating a distance deflection among the laser beams being projected using the measured relative distances among the laser beams.

17. The method of claim 16, wherein the distance deflection dₙ₊₁ is calculated by the equation below:
dₙ₊₁=(Xₙ+dₙ)−Xₙ₊₁;
wherein Xₙ and Xₙ₊₁ refer to relative distances among the projected laser beams, and
wherein d₀ is 0.

18. The method of claim 14, wherein the stage is moved by a predetermined distance in a scanning direction, and
wherein the laser beams are continuously projected to the exposed surface according to the movement of the stage.

19. The method of claim 18, further comprising:
measuring relative distances among the laser beams being continuously projected;
wherein the straightness is measured by calculating a distance deflection among the laser beams being continuously projected using the measured relative distances among the laser beams.

20. The method of claim 19, wherein the distance deflection dₙ₊₁ is calculated by the equation below:
dₙ₊₁=(Xₙ+dₙ)−Xₙ₊₁;
wherein Xₙ and Xₙ₊₁ refer to relative distances among the continuously projected laser beams, and
wherein d₀ is 0.
